(19) United States
(12) Patent Application Publication
(10) Pub. No.: US 2015/0291472 A1
(43) Pub. Date: Oct. 15, 2015

(54) METHOD FOR THE PRODUCTION OF THIN SHEET GLASS

(71) Applicants: SAINT-GOBAIN GLASS FRANCE, Courbevoie (FR); SAINT-GOBAIN ADFORS, Chambery (FR)

(72) Inventors: Rene Gy, Bondy (FR); Mathieu Joanicot, Chatenay Malabry (FR); Anne Choulet, Levallois (FR)

(73) Assignees: SAINT-GOBAIN GLASS FRANCE, Courbevoie (FR); SAINT-GOBAIN ADFORS, Chambery (FR)

(21) Appl. No.: 14/438,990

(22) PCT Filed: Oct. 28, 2013
(86) PCT No.: PCT/FR2013/052576

§ 371 Date: Apr. 28, 2015

(30) Foreign Application Priority Data
Oct. 29, 2012 (FR) 1260293

(51) Int. Cl. C03C 25/10

(52) U.S. Cl. CPC C03C 25/1095

(57) ABSTRACT

The invention relates to a process for manufacturing flat glass, comprising, in succession:
(a) immersing a glass textile into a molten glass bath so as to obtain a glass textile impregnated with molten glass, the glass forming the fibers of the glass textile having a softening temperature above that of the molten glass bath,
(b) removing the impregnated textile from the molten glass bath, and
(c) cooling the impregnated glass textile removed from the molten glass bath so as to obtain a glass sheet,
   and to a glass sheet manufactured using such a process.

The present invention relates to a novel process for manufacturing flat glass, in particular thin glass sheets comprising a glass textile incorporated in a glass matrix.

Many glass manufacturers have for a few years produced what is referred to in English as ultra-thin glass (“verre pelliculaire” or “verre ultramince” in French) having a thickness comprised between a few tens of microns and about 200 μm. This glass, manufactured by float or fusion draw process, is available in large sheets or in the form of continuous strips. The thinnest ultra-thin glass is flexible and may be rolled up. This flexibility allows it to be used in industrial processes conventionally reserved for films and sheets made of plastic, in particular roll-to-roll processing.

The fusion draw process results in thin, transparent glass that is is characterized by its exceptional surface smoothness, particularly important in high-technology applications such as LCD screens. However, the fusion draw process is complex, unproductive and difficult to control, and the high cost of the glass it produces is prohibitive for many applications.

The present invention provides a replacement product for known thin and ultra-thin glass, and a manufacturing process that is considerably simpler than the fusion draw process.

Most of the thin glasses of the present invention have an optical quality (transparency) lower than that of known thin glass. However, their surface quality is satisfactory, even equivalent to that of known ultra-thin glass. They are fabricated from cheap raw materials available in large amounts and in various qualities.

The basic idea behind the present invention is to take advantage of the similarity between glass textiles and ultra-thin glass. Specifically, these two types of products have a similar chemical composition, geometry, and mechanical behavior, and mainly differ in their permeability to fluids and their transparency.

The process of the present invention decreases and even removes the permeability of glass textiles to fluids, and increases their transparency to light, thus making them more like thin and ultra-thin glass.

To achieve this objective, a glass textile has its apertures filled, its scattering interfaces reduced in number, and its surface smoothed by incorporating it into a glass matrix by immersing it into a bath of molten glass. During said immersion impregnation, the glass textile is not completely melted, thereby guaranteeing that the assembly retains sufficient mechanical strength during the cooling step, thus allowing a uniform tensile force to be applied and a good planarity to be obtained.

The process of the present invention is characterized by a very high process flexibility. Specifically, both the glass textile and the glass matrix may be independently chosen from a very large number of products available on the market, the only constraint being that the matrix material must have a softening temperature below that of the glass textile. The process of the present invention may be implemented with tools that require relatively few large investments, which represents a considerable advantage over float and fusion draw processes.

Thus, one subject of the present invention is a process for manufacturing flat glass, comprising in succession:

(a) immersing a glass textile into a molten glass bath so as to obtain a glass textile impregnated with molten glass, the glass forming the fibers of the glass textile having a softening temperature above that of the molten glass bath,

(b) removing the impregnated textile from the molten glass bath, and

(c) cooling the impregnated glass textile removed from the molten glass bath so as to obtain a glass sheet.

In the present application the expression “softening temperature” denotes what is called the Littleton temperature, also called the Littleton point, determined according to standard ASTM C338. This is the temperature at which the viscosity of a glass fiber measured according to this method is equal to 1×10^{6.6} Pa·s.

The expression “molten glass composition” or “molten glass bath” is, in the present application, understood to mean a fluid glass composition heated to a temperature above its Littleton softening point.

Prior to, or at the moment when the glass textile is immersed in the molten glass composition, the latter is preferably heated to a temperature above, by at least 100° C. and preferably by at least 200° C., its Littleton softening point.

Before step (a) of the process of the invention, the glass is heated to a temperature significantly above its softening temperature so as to be available in the form of a glass bath having a sufficiently low viscosity, preferably a viscosity comprised between 10 and 1×10⁶ Pa·s, preferably between 1×10² and 1×10⁵ Pa·s, and in particular between 1×10³ and 1×10⁴ Pa·s.

Step (a) comprises immersing the glass textile into said molten glass bath, or even applying a film of the molten glass composition to the glass textile by another means. Preferably, all of the glass textile is coated with liquid glass in this way. When the molten glass composition is sufficiently viscous and applied to a single side of the glass textile, the product obtained has an asymmetric structure where, on one side, the textile texture of the support is completely planarized and covered by the glass film whereas, on the other side, the texture is still perfectly apparent and exposed. Passing the glass textile into a glass bath of course results in a symmetrical structure where both sides of the product are planarized by a glass layer.

The glass textile impregnated with molten glass is then removed from the glass bath in a way that removes excess glass and limits the overall thickness of the final glass sheet. The excess glass may flow freely from the impregnated glass textile, or indeed the impregnated glass textile may be passed through a slit or a doctor blade system. Preferably, the molten glass is sufficiently fluid to flow spontaneously from the impregnated glass textile.

Although the products obtained by the process of the present invention are “flat” products in the sense that overall they preserve the geometry of the textile, which is characterized by two main surfaces that lie parallel to each other, the process of the present invention is in no way limited to perfectly flat products. Specifically, initial trials carried out by the Applicant resulted in materials that were very satisfying from an aesthetic point of view, and it would be entirely envisageable to use them to manufacture decorative objects of various shapes, such as lampshades, tubes, corrugated walls, etc.

With regard to more technical applications, the products obtained by the process of the present invention however preferably have a both flat and planar shape. To obtain a final product with satisfactory planarity, it is essential to stretch the glass textile at least during the cooling step, and preferably throughout the process.

In a preferred embodiment, the glass textile is therefore subjected to a tensile force in at least one direction in the plane of the glass textile, throughout step (a) and (b), and this tensile force is preferably maintained during step (c), at least until the product obtained has stiffened.

Placing the glass textile under tension during the step of immersing and removing the glass textile and the cooling step is perfectly compatible with and even necessary for implementation of a continuous process, which is a preferred embodiment of the present invention.

In such a continual process, the glass textile is a continuous strip and steps (a), (b) and (c) are continuous steps implemented upstream and downstream in the processing line, the direction of the tensile force being parallel to the run direction of the continuous strip of glass textile.

The glass textile may be a nonwoven or even a woven. When it is a woven, the number of warp threads and/or the number of weft threads is typically comprised between 3 and 100 per cm, and preferably between 10 and 80 per cm.

The objective of the present invention is to fill all the holes in the glass textile. To achieve this aim, it is indispensable to ensure that the apertures of the starting textile are not too large. Glass woven or nonwoven textiles with apertures having an average equivalent diameter smaller than 1 mm, and preferably smaller than 0.1 mm, will therefore preferably be chosen.

The weight per unit area of the glass textiles used is generally comprised between 50 and 500 g/m², preferably between 80 and 400 g/m², and in particular between 100 and 200 g/m².

The amount of glass applied in the form of the molten glass composition is comprised in the interval ranging from 100 to 2000 g/m², and preferably from 200 to 1500 g/m².

After the desired amount of molten glass has been applied, the glass textile impregnated with molten glass is cooled (step (c)). This cooling may be carried out passively or in a controlled way, the impregnated textile being kept in a hot environment for example. In order to ensure a good temperature uniformity throughout the cooling step, it may also be useful to heat certain zones liable to cool more rapidly than others.

The hot glass textile obtained in step (b) preferably does not make contact with any solids or liquids before it has cooled to a temperature below, by at least 50° C. and preferably by at least 100° C., the softening temperature of the glass forming the molten glass composition.

Some samples prepared by the Applicant have proved to be highly diffusive. This high diffusiveness has been attributed, on the one hand, to the large difference between the refractive index of the glass forming the textile and that of the glass forming the matrix. When it is desired to obtain a high diffusiveness, for example in the field of OLED substrates, care will be taken to ensure that the refractive index of the glass forming the matrix is higher, by at least 0.01 and preferably by at least 0.05, than the refractive index of the glass textile.

In contrast, when it is desired to increase, as much as possible, the transparency of the final products, the refractive index of the glass forming the glass bath will need to be substantially identical to that of the glass forming the glass textile.

Another effect explaining the high diffusivity of products prepared in the way described in the examples below is the presence of a large number of gas bubbles. Impregnating the glass with a fined molten glass composition will certainly allow the number of these scattering bubbles to be decreased.

Microscopy of cross sections of the products showed that the high diffusiveness is also due, at least in part, to insufficient wetting of the glass fibers by the liquid glass, preventing satisfactory penetration of the matrix into the center of the multi-filament fibers. The Applicant believes that it will be possible to alleviate, even overcome, this problem by limiting the viscosity of the liquid glass to values below 1×10⁴ Pa·s, or even below 1×10³ Pa·s and/or by increasing the time for which the glass textile remains in the molten glass bath.

To the knowledge of the Applicant, at the present time no description of a flat product obtained by combining a glass textile and a molten glass composition exists. International patent application WO 88/05031 does admittedly disclose glass slabs reinforced with textile structures, in particular glass textiles, but these slabs have thicknesses that are considerably larger than those of the thin glass sheets of the present invention.

Such a flat product, or glass sheet, capable of being manufactured by a process such as described above, is therefore another subject of the present invention.

This glass sheet preferably has a thickness comprised between 50 μm and 1000 μm, and in particular between 100 μm and 800 μm.

In this glass sheet, the structure of the glass textile may, due to its transparency, be visible to the naked eye. This structure may also be masked by a highly diffusive glass film, or it may even no longer be visible due to the disappearance of the interfaces between the textile material and the enamel coating the latter.

### EXAMPLE

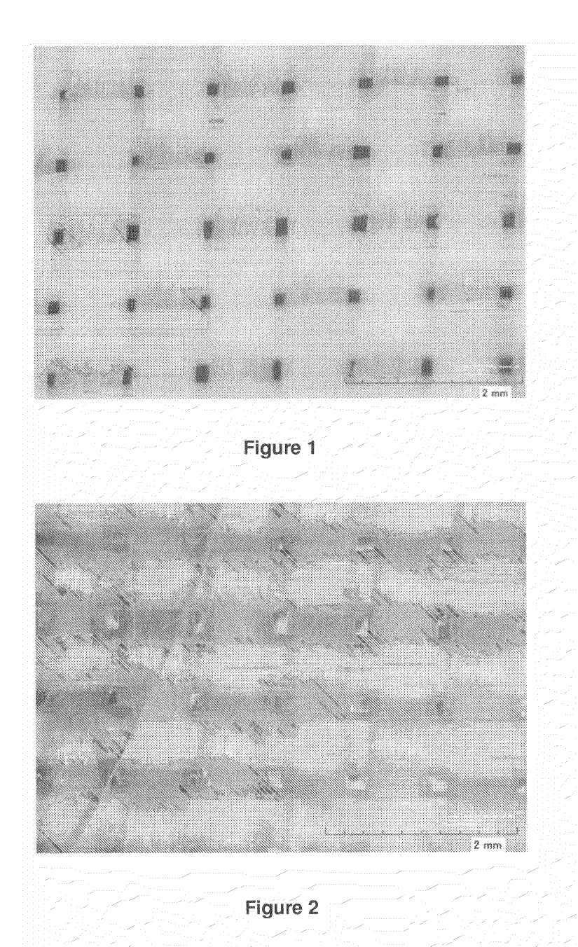

FIG. 1 shows a glass textile having a weight per unit area of 165 g/m². This textile was immersed in a bath of molten glass, removed and cooled. FIG. 2 shows that the glass matrix formed is almost perfectly transparent and the textile structure clearly visible.

1. A process for manufacturing flat glass, the process comprising, in succession:
(a) immersing a glass textile into a molten glass bath so as to obtain a glass textile impregnated with molten glass, the glass forming the fibers of the glass textile having a softening temperature above that of the molten glass bath;
(b) removing the impregnated textile from the molten glass bath; and
(c) cooling the impregnated glass textile removed from the molten glass bath so as to obtain a glass sheet.

2. The process of claim 1, wherein softening temperature of the glass forming the fibers of the glass textile is above, by at least 100° C., that of the glass forming the molten glass bath.

3. The process of claim 1, further comprising subjecting the glass textile to a tensile force in at least one direction in the plane of the glass textile, throughout step (a) and (b), such that the tensile force is maintained during step (c) at least until the product obtained has stiffened.

4. The process of claim 1, wherein the glass textile has a weight per unit area of between 50 and 500 g/m².

5. The process of claim 1, wherein an amount of glass applied in the form of the molten glass composition ranges from 100 to 2000 g/m².

6. The process of claim 1, wherein an average equivalent diameter of the apertures of the glass textile is smaller than 1 mm.

7. The process of claim 1, wherein the glass textile is a woven having a number of warp threads and/or a number of weft threads comprised between 3 and 100/cm.

8. The process of claim 1, wherein the glass textile is a nonwoven.

9. The process of claim 1, wherein a hot glass textile obtained in step (b) does not make contact with any solids or liquids before cooling to a temperature below, by at least 50° C., the softening temperature of the glass forming the molten glass composition.

10. The process of claim 1, wherein a refractive index of the glass forming the glass bath is substantially identical to that of the glass forming the glass textile.

11. The process of claim 1, wherein a refractive index of the glass forming the glass bath is higher, by at least 0.01, than the refractive index of the glass textile.

12. A glass sheet manufactured by the process of claim 1.

13. The glass sheet of claim 12, having a thickness between 50 μm and 1000 μm.

14. The glass sheet of claim 12, wherein a structure of the glass textile is, due to its transparency, visible to the naked eye.

15. The process of claim 1, wherein softening temperature of the glass forming the fibers of the glass textile is above, by at least 200° C., that of the glass forming the molten glass bath.

16. The process of claim 1, wherein the glass textile has a weight per unit area of between 80 and 400 g/m².

17. The process of claim 1, wherein an amount of glass applied in the form of the molten glass composition ranges from 200 to 1500 g/m².

18. The process of claim 1, wherein an average equivalent diameter of the apertures of the glass textile is smaller than 0.1 mm.

19. The process of claim 1, wherein the glass textile is a woven having a number of warp threads and/or a number of weft threads comprised between 10 and 80/cm.

20. The process of claim 1, wherein a hot glass textile obtained in step (b) does not make contact with any solids or liquids before cooling to a temperature below, by at least 100° C., the softening temperature of the glass forming the molten glass composition.
